(19) United States
(12) Patent Application Publication
(10) Pub. No.: US 2012/0184241 A1
(43) Pub. Date: Jul. 19, 2012

(54) SYSTEM AND METHOD FOR AUTOMATED PREPAID WIRELESS PHONE REFILLS

(76) Inventors: Ramin Heydari, Reston, VA (US); Gregory Taylor, Hollywood, CA (US)

(21) Appl. No.: 13/183,416

(22) Filed: Jul. 14, 2011

Related U.S. Application Data
(60) Provisional application No. 61/364,178, filed on Jul. 14, 2010.
(60) Provisional application No. 61/366,733, filed on Jul. 22, 2010.
(60) Provisional application No. 61/423,045, filed on Dec. 14, 2010.

(51) Int. Cl. H04W 4/24

(52) U.S. Cl. 455/406

(57) ABSTRACT

A method and system for refilling minutes for prepaid wireless phones is provided. Also provided is a computer-readable storage medium including a program, which when executed on a processor performs an operation. The method includes executing a recurring charge to a user account, the user account being stored in a database, and automatically crediting a device associated with the user account with prepaid minutes in response to executing the recurring charge.

This application claims the benefit of provisional patent applications Nos. 61/364,178, 61/366,733, and 61/423,045, filed Jul. 14, 2010, Jul. 22, 2010, and Dec. 14, 2010, respectively, which are hereby incorporated by reference in their entireties.

### BACKGROUND

1. Field of the Invention

The present invention relates generally to the purchase of goods and services, and more particularly for refilling minutes for prepaid wireless phones.

2. Description of Related Art

Right now, prepaid wireless customers must return to a prepaid wireless phone refill retailer every time they need more minutes. This system is inefficient and inconvenient for customers. It is not profitable for retailers and distributors to sell a prepaid wireless phone to a customer, bringing that customer to the phone carrier, and then have the customer refill their minutes directly with the carrier, cutting the retailers and distributors out of those repeat purchases that they could make a commission on.

Needs exist for improved systems and methods for providing and selling prepaid wireless phone refills.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. In certain embodiments, the disclosed embodiments may include one or more of the features described herein.

The terms refill and recharge are used interchangeably herein.

In accordance to one embodiment of the invention, a computer-implemented method is provided. The computer-implemented method includes executing a recurring charge to a user account, the user account being stored in a database, and automatically crediting a device associated with the user account with prepaid minutes in response to executing the recurring charge.

In accordance to another embodiment of the invention, another computer-implemented method is provided. The computer-implemented method includes receiving a payment for a refill of prepaid minutes for a device, generating an electronic personal identification number for a user account stored in a database in response to receiving the payment, wherein the user account is associated with the device, and receiving an activation indication to assign the prepaid minutes to the user account, the activation indication comprising the electronic personal identification number.

In accordance to yet another embodiment of the invention, a system is provided. The system includes a processor and a memory containing a program, which, when executed by the processor, is configured to perform an operation. The operation may include executing a recurring charge to a user account, the user account being stored in a database, and automatically crediting a device associated with the user account with prepaid minutes in response to executing the recurring charge.

In accordance to yet another embodiment of the invention, another system is provided. The system includes a processor and a memory containing a program, which, when executed by the processor, is configured to perform an operation. The operation includes receiving a payment for a refill of prepaid minutes for a device, generating an electronic personal identification number for a user account stored in a database in response to receiving the payment, wherein the user account is associated with the device, and receiving an activation indication to assign the prepaid minutes to the user account, the activation indication comprising the electronic personal identification number.

In accordance to yet another embodiment of the invention, a computer-readable storage medium includes a program, which when executed on a processor performs an operation. The operation may include executing a recurring charge to a user account, the user account being stored in a database, and automatically crediting a device associated with the user account with prepaid minutes in response to executing the recurring charge.

In accordance to yet another embodiment of the invention, another computer-readable storage medium includes a program, which when executed on a processor performs an operation. The operation includes receiving a payment for a refill of prepaid minutes for a device, generating an electronic personal identification number for a user account stored in a database in response to receiving the payment, wherein the user account is associated with the device, and receiving an activation indication to assign the prepaid minutes to the user account, the activation indication comprising the electronic personal identification number.

These and other objectives and features of the invention are apparent in the disclosure, which includes the above and ongoing written specification.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 shows a block diagram illustrating an exemplary computing environment according to one embodiment of the present invention.

FIG. 2 is a screenshot of a user interface start page for a prepaid wireless refill program, in accordance to one embodiment of the present invention.

FIG. 3 is a screenshot of a user interface for an auto-recharge sign up account information page for a prepaid wireless refill program, in accordance to one embodiment of the present invention.

FIG. 4 is a screenshot of a user interface customer manager page for a prepaid wireless refill program, in accordance to one embodiment of the present invention.

FIG. 5 is a screenshot of a user interface for an auto-recharge sign up credit card information page for a prepaid wireless refill program, in accordance to one embodiment of the present invention.

FIG. 6 is a screenshot of a user interface for an auto-recharge sign up ACH information page for a prepaid wireless refill program, in accordance to one embodiment of the present invention.

FIG. 7 is a screenshot of a user interface for an auto-recharge activation page for a prepaid wireless refill program, in accordance to one embodiment of the present invention.

FIG. 8 is a screenshot of a user interface for an auto-recharge activation page for a prepaid wireless refill program, in accordance to one embodiment of the present invention.

FIG. 9 is a screenshot of a user interface for an auto-recharge receipt page for a prepaid wireless refill program, in accordance to one embodiment of the present invention.

FIG. 10 is a flowchart illustrating operations for a prepaid wireless refill program, in accordance to one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Embodiments of the present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

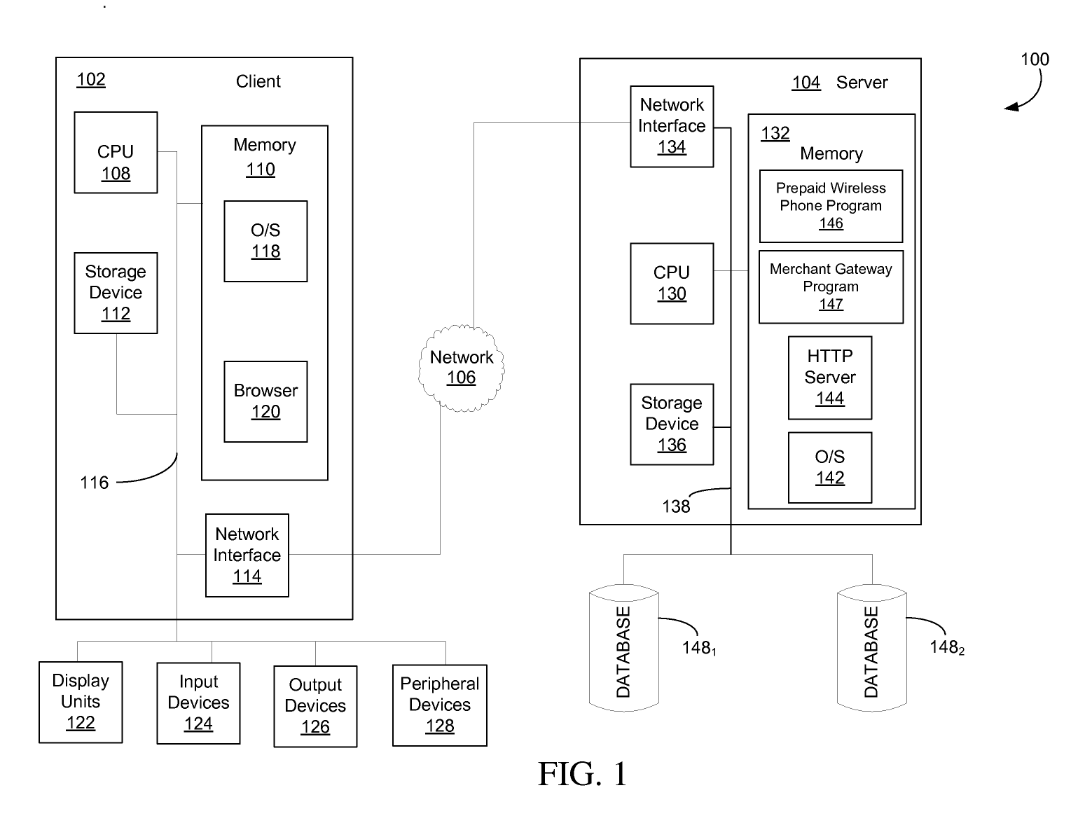

One embodiment of the invention is implemented as a program product for use with a computer system such as, for example, the computing environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information conveyed to a computer by a communications medium, such as through a computer or telephone network, including wireless communications.

The latter embodiment specifically includes information downloaded from the Internet and/or other networks. Such signal-bearing media, when carrying computer-readable instructions that direct the functions of the present invention, represent embodiments of the present invention. In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in one or more specific embodiments of the invention. However, it should be appreciated that any particular program nomenclature that follows is used merely for convenience, and thus the invention should not be limited to use solely in any specific application identified and/or implied by such nomenclature. In this regard, references to particular definitional languages, such as HTML and XML, are illustrative in nature and do not serve to limit the claims. It is broadly contemplated that the invention is applicable regardless of the particular schema and/or language used to define network resource content.

A new automatic refill program and method deployed by retailers allows them to compete with direct refills from carriers, allowing them to sign up customers for convenient automatic refills of their prepaid wireless phone minutes and eliminating the need for prepaid cards or trips to the retailer. This allows the distributors and retailers to continue to receive incremental revenue on each recharge and to maintain an ongoing relationship with customers and to collect their information and market to them if desired.

The new system and method for refilling prepaid wireless phone minutes gives customers the option to automatically refill their prepaid plan monthly, similar to a normal post paid contract. In a prepaid wireless distribution system, the top-level wholesaler purchases minutes from wireless service providers at, for example, a 20% discount. Typically, the wholesaler takes 1% of this discount as profit and passes 19% on to its distributor customers. The distributors then take 1-2% and pass the remaining discount to the distribution level below them and so on, until the retailer sells the refill minutes to an end customer for about 15% profit.

In the new system and method, rather than the end customer returning to a retailer to purchase refill minutes whenever they need more, the retailer takes payment information from the end customers and has them agree to auto-recharge monthly. A software application may then accept this information from the retailer and charge the customers independently each month, automatically recharging the customers' minutes and sending the distributors and retailers commission checks.

The new prepaid wireless refill program eliminates the need for an end customer to return to a retail establishment repeatedly. This is more convenient for the customer because the customer would no longer need to travel anywhere for a refill. This is also more convenient for a retail establishment, which does not have to devote further staff resources to handling the refills after the initial transaction. It also builds a reliable, loyal customer base for the retailer that generates commissions regularly each month, rather than stopping at whatever retail establishment they happen to be near when they run low on minutes.

Turning now to FIG. 1, a block diagram illustrating an exemplary computing environment 100, in accordance with an embodiment of the present invention, is illustrated. In general, the computing environment 100 includes a client computer 102 (e.g., a user's computer or a point-of-sale (POS) computer), and a server computer 104. The client computer 102 and the server computer 104 may be components of the same computer system and/or may be connected via a network 106, such as the Internet, an intranet, a local area network (LAN) and/or the like.

As shown, the client computer 102 may include a central processing unit (CPU) 108 connected to a memory 110, a storage device 112, and a network interface 114 via a bus 116. The CPU 108 may be included to be representative of a single CPU, multiple CPUs, a single CPU having multiple processing cores, and/or the like. The storage device 112 may store application programs and/or data for use by the client computer 102. Examples of the storage device 112 may include one or more hard-disk drives, flash memory devices, optical media and/or the like.

The client computer 102 may be connected to the data communications network 106 (e.g., a local area network (LAN), which itself may be connected to other networks such as the Internet) using the network interface 114. The memory 110 can be one memory device or a combination of memory devices, including a random access memory, a nonvolatile and/or backup memory (e.g., programmable or flash memories, read-only memories, etc.). Illustratively, the memory 110 of client computer 102 may store an operating system 118 that may be used to manage hardware and/or software executing on the client computer 102. As shown, memory 110 may also include a browser program 120 that, when executed by CPU 108, may provide support for navigating between various servers and/or locating network addresses at one or more servers (e.g., server computer 104).

The client computer 102 may be connected to one or more display units 122, input devices 124, output devices 126 and/or peripheral devices 128. The display units 122 may be internal and/or external monitors, television screens, handheld device displays, and/or the like. The input devices 124 may be any one of a keyboard, a mouse, a track-ball, a stylus, a mouse pad, a mouse button, a joystick, a scanner, a microphone and/or the like. The output devices 126 may be any one of a monitor, a printer, a plotter, a copier and/or any other output device. The peripheral devices 128 may be any other device that can be coupled to a computer: a CD/DVD drive capable of reading and/or writing to physical digital media, a USB device, a Zip Drive, an external floppy drive, an external hard drive, a phone and/or a broadband modem, a router/gateway, an access point and/or the like.

Similar to the client computer 102, the server computer 104 may include a CPU 130, a memory 132, a network interface device 134, and/or a storage device 136, coupled via a bus 138. The memory 132 may be, in accordance with one or more embodiments, a random access memory sufficiently large to hold the necessary programming and data structures that are located on the server computer 104. As shown, the memory 132 may store an operating system 140 used to manage server hardware and/or software executing on the server computer 102.

Illustratively, the memory 132 may also include a hypertext transfer protocol (http) server 144 that may be configured to service requests from the client computer 102. For example, the http server 144 may respond to requests for access to electronic resources (e.g., HTML documents, network information, and/or the like) residing on the server computer 104. However, one of ordinary skill in the art will recognize that the http server 144 is merely illustrative and embodiments of the invention may be adapted to support both known and unknown protocols.

The programming and data structures of the http server 144 may be accessed and executed by the CPU 130 as needed during operation. The server computer 104 may connect to the network 106 using the network interface device 134 (e.g., an analog modem, a wired network card, a wireless network device, and/or the like).

In one embodiment, users may interact with the server computer 104 using a graphical user interface (GUI). In a particular embodiment, the GUI content may comprise HTML documents (i.e., web pages) rendered on the display unit 122 coupled with the client computer 102 using the browser 120. In one embodiment, the web pages may include pages that allow a user to refill minutes for a prepaid wireless telephone.

The memory 132 may further include a prepaid wireless refill program 146. The prepaid wireless refill program 146 may comprise a software application configured to provide the ability (e.g., via the GUI) for a user to create user accounts, store information regarding the user accounts in a database, and purchase prepaid minutes for the established user accounts.

Accordingly, the server computer 104 may also be coupled to a plurality of databases 148₁, 148₂ which may include a relational database 148₁ that is queried using an SQL query, or an XML database 148₂ queried using an XML query. Embodiments of the instant invention, however, are not limited to any particular physical database storage mechanism and may readily be extended to operate on other such mechanisms, whether currently known or unknown. While the databases 148₁ and 148₂ are illustrated as being external to the server system, it is noted that the databases 148₁ and 148₂ may exist on a local storage device (e.g., storage device 136) of the server computer 104, or may be accessed over the network 106.

The memory 132 may also include a merchant gateway program 147. The merchant gateway program 147 may be configured to transfer payment information entered using the client computer 102 to other server computers connected to the network 106. For example, a server maintained by an acquiring bank (i.e., a bank that accepts credit and/or debit card payments on behalf of the merchant) and a server maintained by an issuing bank (i.e. the bank that offers the credit and/or debit card directly to the consumer) may be connected to the network 106. The acquiring bank's server may execute a payment processor program, which facilitates communication between the acquiring bank and an issuing bank The issuing bank's server may execute also execute a payment processor program, which may approve or decline the transaction.

The following provides an illustrative example of a sample payment transaction. Initially, a customer places an order with the prepaid wireless refill program 146 using the client computer 102. The prepaid wireless refill program 146 then forwards the transaction details to the payment gateway program 147. The payment gateway program 147 then forwards the transaction information to the payment processor program used by the acquiring bank. The payment processor program then forwards the transaction information to the issuing bank's payment processor program. The issuing bank's payment processor program receives the authorization request and sends a response back to the acquiring bank's payment processor program with a response code. The response code identifies whether or not the transaction is approved or declined. In the event that the transaction is declined, the response code also identifies the reason why the transaction was declined. The acquiring bank's payment processor program forwards the response to the payment gateway program 147. The payment gateway program 147 receives the response, and forwards it on to the prepaid wireless refill program 146, where it is interpreted as a relevant response then relayed back to the user and the merchant. (e.g., via the GUI).

FIG. 2 shows a screenshot of a user interface for a start page 200 for the prepaid wireless refill program 146, in accordance to an embodiment of the present invention. In some embodiments, this start page is accessed by navigating to a website address (via the browser program 120). The start page may be accessed, for example, by a retailer from a behind-the-counter computer terminal. The browser program 120 may display a graphical user interface for the prepaid wireless refill program 146 that is rendered on the display unit 122 coupled with the client computer 102. The browser program 120 may also connect to a remote computing device, such as an Internet server or other server (e.g., the server computer 104), to transmit information input into the user interface. Accordingly, in some such embodiments, some software applications are located on the client computer 102 and others server computer 104.

In the embodiment shown, the software application permits a retailer to perform a number of operations and to retrieve various information for managing its mobile services and products. In the left navigation bar is a “Creat New Account” link 201.

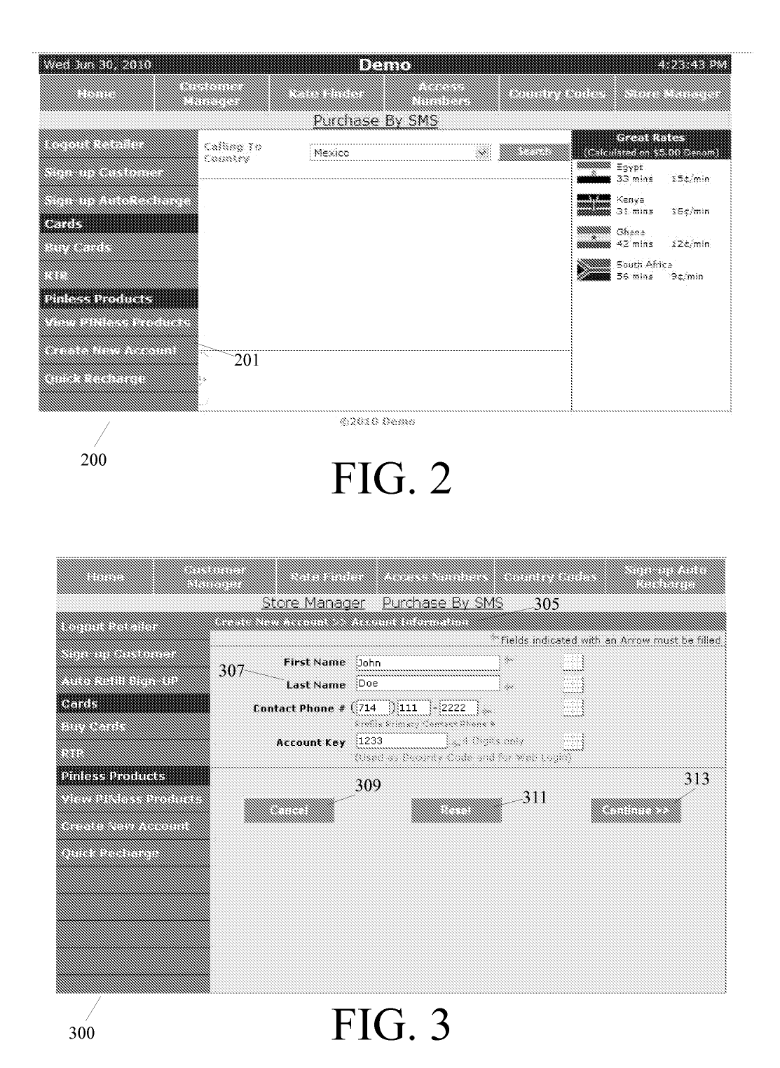

This start page is merely an exemplary implementation, and a person of skill in the art would recognize that the appearance of this page may be modified in any number of ways without affecting its functionality and suitability for these embodiments. This page also displays a number of options that are entirely separate from or complementary to the system described herein, which are entirely optional. The “Create New Account” function when selected brings the user to FIG. 3 of the user interface.

FIG. 3 is a screenshot of a user interface displaying a new account information page 300 for the prepaid wireless refill program 146, in accordance to an embodiment of the present invention. Page title 305 shows that the user is completing account information in the process of creating a new account. The new account can be for an individual customer or business owner, and may have sub-accounts. A number of input fields 307 accept initial information for establishing a new account from a retailer, which is submitted electronically across the network 106 to a remote device such as the server computer 104, which receives and stores the information, for example in the appropriate database 148₁, 148₂. A cancel button 309 allows the user to cancel the new account creation, a reset button 311 clears the fields entered, and a continue button 313 submits the information entered in the fields and creates the new account.

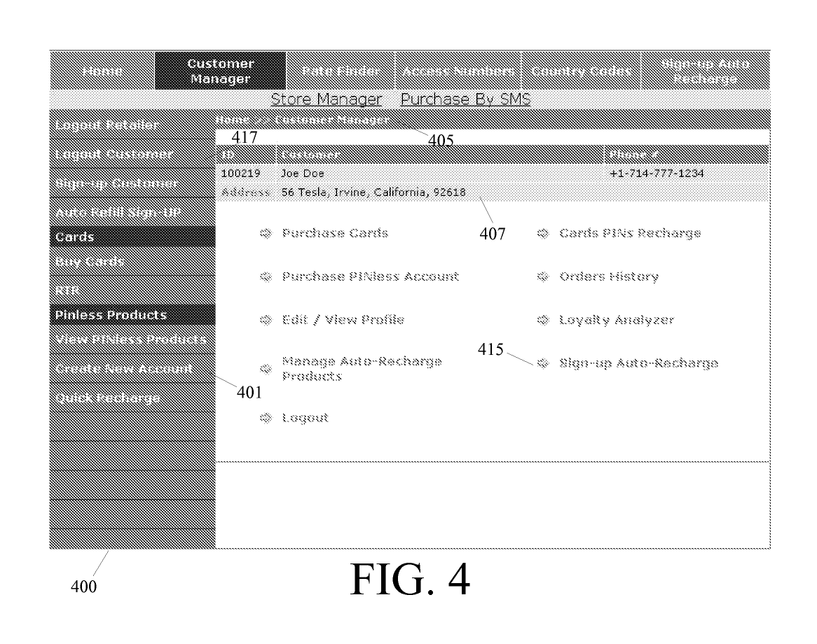

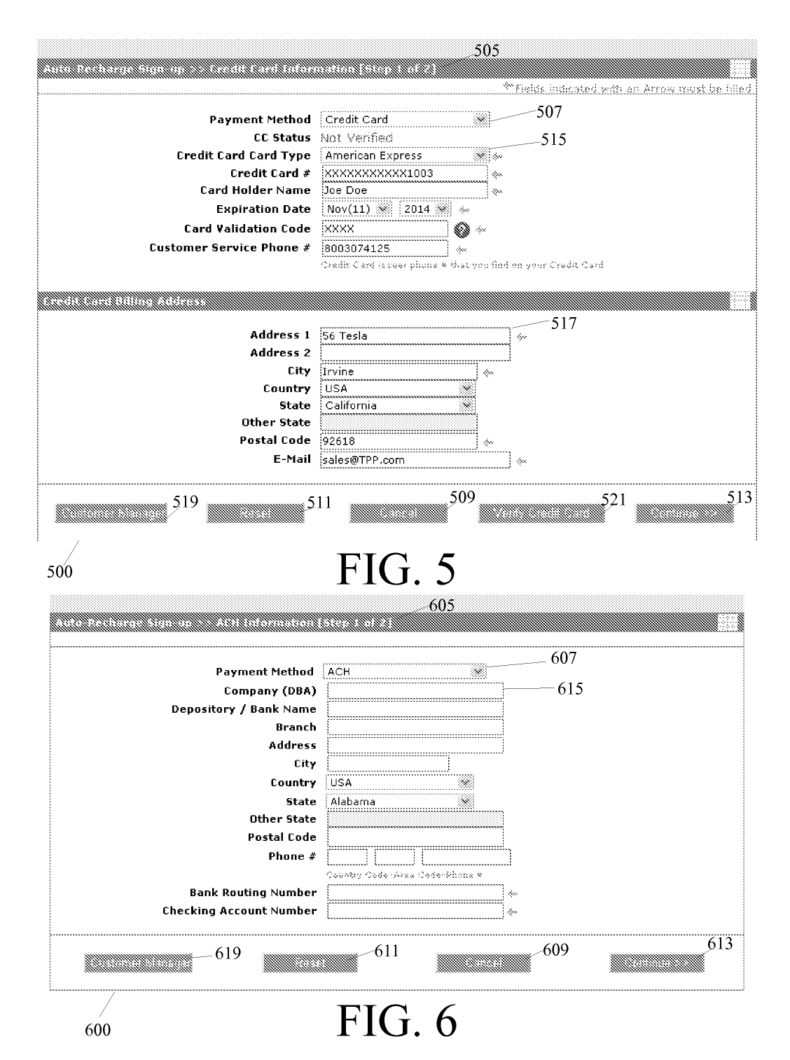

Once the account is created, a user is brought to a Customer Management page 400 with various customer options as shown in FIG. 4. The recently-created customer account is logged in and the information of the logged-in customer is displayed 407, preventing confusion. The customer can be logged out with Logout Customer link 417 that appears in the side navigation bar. The user can select the “Sign-up AutoRecharge” option from the options to bring the user to FIG. 5 of the user interface and register the account for automatic refills.

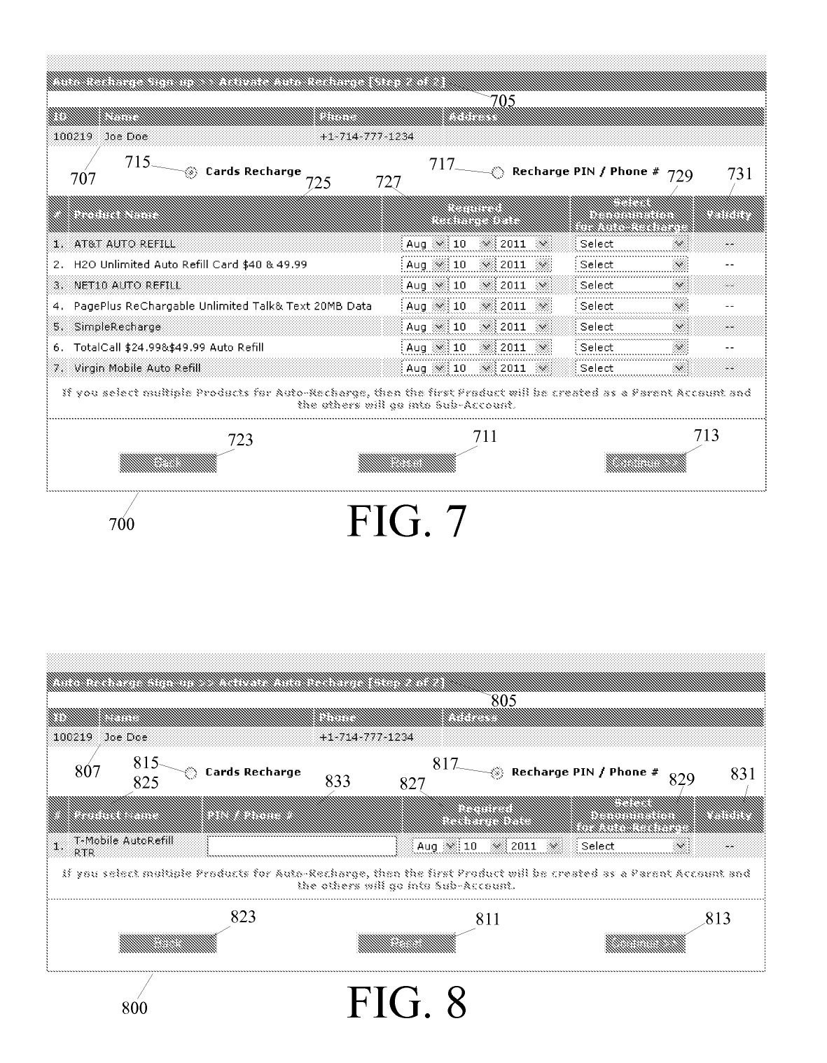

FIG. 5 is a screenshot of a user interface for an auto-recharge sign up page for the prepaid wireless refill program 146, in accordance to an embodiment of the present invention. This page contains a number of input fields 507, 515, 517 into which an end customer's billing 515 and contact 517 information can be inputted by a retailer and submitted for transmission to the server computer 104 executing the prepaid wireless refill program 146. The same billing information (e.g., credit card or bank account number) and/or account can be associated with multiple wireless phone numbers, allowing all the phones to be automatically refilled using this same billing information. The payment method selection 507 determines the fields 515, 517 which are displayed and must be completed. Customer Manager button 519 returns the user to the Customer Manager page, Verify Credit Card button 521 provides credit card verification prior to completion of the sign-up process, and continue button 513 leads to step two of the auto-recharge signup as shown in FIG. 7.

If ACH is selected as the payment method 607, appropriate fields 615 are displayed for completion. Continue button 613 leads to step two of the auto-recharge signup as shown in FIG. 7.

In some embodiments, the billing information is then stored on the appropriate database 148₁, 148₂. In some embodiments, some or all of this information is collected automatically from the customer's payment method. For example, a customer's credit card number and other billing information may be collected in some embodiments by a credit card terminal when the card is swiped, capturing the information and storing it for future use (e.g., on a connected computing device). The clerk would then explain to the customer the auto-recharge service and have the customer sign a receipt agreeing to the recurring (for example, daily, weekly, bi-weekly, monthly, semi-annually, annually) charge. The clerk would not need to manually collect and enter the information, increasing convenience for the customer and reducing costs for the retailer. In other embodiments, the information may be collected from a smart card/device or other payment method using, for example, RFID or even a direct wireless or wired electronic connection.

In some embodiments, the credit card terminal or another machine pulls information off of an identification device, such as a driver's license or other ID card, a passport with an embedded chip, etc., when it is swiped or otherwise read mechanically/electronically. That way, a customer's contact information (name, address, etc.) can be pulled automatically in the same way as the payment information, again reducing the data entry and time at the clerk and increasing convenience.

In some embodiments, magnetic cards or similar devices may contain a product the customer wants (e.g., prepaid wireless phone refill minutes). In this case, the customer may take the card (e.g., from a retail counter or rack) and hand it to the clerk. In an exemplary embodiment, the product card may be swiped first, followed by the customer's payment credit card and driver's license, thereby linking the credit card and license information to the customer's product account. This makes the auto-recharge sign-up process painless and fast for the customer, and may result in an increase in sign-ups and recurring revenue. In some embodiments, the collected information automatically populates the screen shown in FIG. 5 or 6. In other embodiments, the information may be transmitted to the sever computer 104 directly without the intermediary of the user interface. Pressing the “Continue>>” button shown in FIG. 5 or 6 leads to the next page prepaid wireless refill program 146, which is shown in FIG. 7.

FIG. 7 is a screenshot of a user interface for an auto-recharge sign up page 700 for the prepaid wireless refill program 146, in accordance to an embodiment of the present invention. Page title 705 shows that this is step 2 of the activate auto-recharge process. On this page, information is displayed for the end customer 707 involved in the transaction, based on the information input previously. The retailer can input whether a card-based recharge 715 or PIN/phone #-based recharge 717 is desired. Based on that selection, fields are displayed for retailer input. The recharges can thus be PIN-based, for example where a recharge PIN is provided and the customer must call a number and enter the PIN to recharge the customer's minutes, or real-time replenishment (RTR), where the phone minutes are recharged directly. Where Cards Recharge 715 is selected, the retailer can input the product 725 that is to be recharged/refilled, the date 727 on which an initial recharge is to be performed, a dollar amount 729 for the recharge, and the period 731 after which the account is to be automatically recharged at a predetermined rate. Once processed, the wireless prepaid phone product will automatically be refilled on the date indicated for the amount indicated, and then periodically after the number of days indicated. The user can select the back button 723 to return to step 1 of the auto-recharge sign-up process shown in FIGS. 5 and 6. Selecting the Continue button 713 brings the user to an auto-recharge receipt page 900.

FIG. 8 is a screenshot of a user interface for an auto-recharge sign up page 800 for the prepaid wireless refill program 146, in accordance to an embodiment of the present invention, where Recharge PIN/Phone # 717 has been selected. Here, in addition to product 825, date 827, dollar amount 829 and period 831, PIN/Phone # 833 is also input. One or multiple carriers can be recharged and the auto-recharge can be established for all carriers at the same time. Selecting the Continue button 813 brings the user to an auto-recharge receipt page 900.

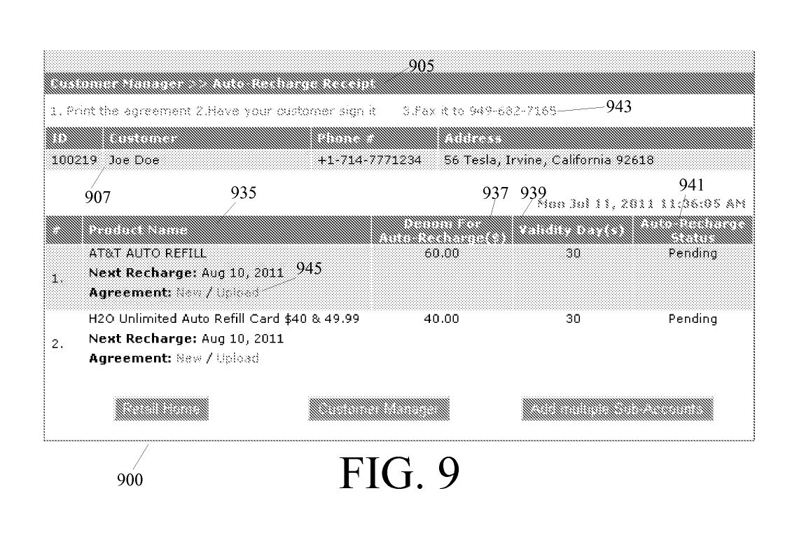

FIG. 9 is a screenshot of a user interface for an auto-recharge receipt page 900 for the prepaid wireless refill program 146, in accordance to an embodiment of the present invention. This shows the status of the auto-recharge account, including information 907, 935, 937, 939, 941 entered in previous steps, and allows a user agreement to be created or uploaded 945, indicating the end customer's permission for automatic periodic billing according to the information input previously. Text 943 instructs the retailer to print the agreement, have the customer sign it, and fax the signed agreement.

In some embodiments, such as the one shown in the figures, the prepaid wireless refill program 146 may be used in conjunction with a point of service prepaid wireless airtime sales system that generates refills electronically, via computer, eliminating the need to order, stock and refill traditional plastic cards. However, the prepaid wireless refill program 146, in some embodiments, may be implemented separately from this point of sale system as a whole, using different software or a different website, or as a part of a different point of sale or other system.

In some embodiments, upon receiving payment for a recharge, the transaction is processed electronically, generating a confirmation and an electronic personal identification number (PIN) for the customer on the point of service system screen. The receipt for the customer contains the instruction to activate the new airtime minutes.

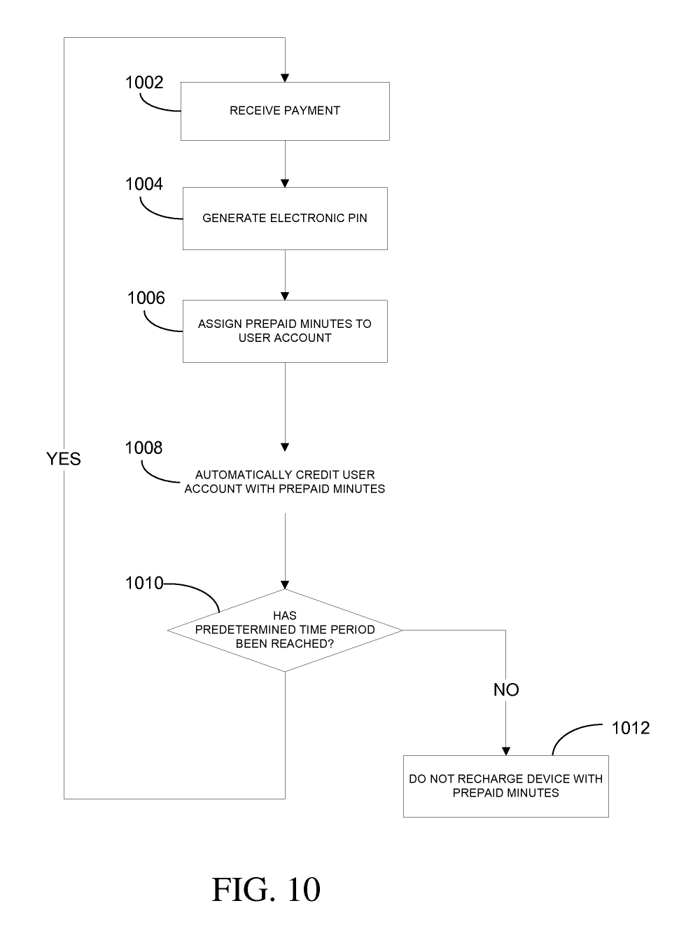

FIG. 10 shows a flowchart illustrating operations for the prepaid wireless system 146, in accordance to an embodiment of the present invention. The operations being at step 1002, where a payment for prepaid minutes for a wireless device is received. At step 1004, an electronic PIN is generated for a particular user account (e.g., the user account for which payment was made). At step 1006, prepaid minutes are assigned to the user account. At step 1008, the device is automatically credited with prepaid minutes. At step 1010, it is determined whether or not a predetermined time period has been reached. If the predetermined time period has not been reached, then at step 1012, a recharge to the wireless device is not made. However, if the predetermined time period has been reached, then the operations return to step 1002, where another payment for prepaid minutes is received.

Advantages of working with this point of sale system include the ease of auto recharge module activation and unlimited inventory, in real time. The retailer never runs out of refills or PINs, as ePINs may be provided electronically any time they are needed, day or night. The point of service system serves as a one-stop shopping center, allowing just one simple interface for all prepaid refills, from any service provider in the system. The retailer saves money on cards and shipping, as the system is computer-based and there is no inventory to maintain and no shipping expenses.

The software may provide reporting and tracking tools to track and verify each transaction to the sales clerk, the location where it was issued, the provider, and the amount of the transaction. This feature ensures accountability and accurate settlement, easy commission and accounting reports, and eliminates the need for invoicing, statements and record keeping. The system may increase sales and create return customers who return to the retailer every time they need refills, and therefore, increase customer loyalty. With the automatic recharge feature, customers never run out of minutes, as every time the balance on their account drops to certain level their credit card is recharged for a preset amount.

The invention is not limited to the particular embodiments described above in detail. Those skilled in the art will recognize that other arrangements could be devised, for example, using various local and remote computing devices including smart phones and tablet computers and various user interfaces. While the invention has been described with reference to specific illustrative embodiments, modifications and variations of the invention may be constructed without departing from the scope of the invention.

We claim:

1. A computer-implemented method, comprising:
executing a recurring charge to a user account, the user account being stored in a database; and
automatically crediting a device associated with the user account with prepaid minutes in response to executing the recurring charge.

2. The method of claim 1, further comprising automatically collecting user information from a user payment method and using the collected user information to create the user account.

3. The method of claim 2, wherein the user information is automatically collected by RFID or wireless or wired electronic connection.

4. The method of claim 1, further comprising automatically collecting user information from a driver's license, ID card or passport.

5. The method of claim 1, further comprising establishing the user account at the time and point of sale of the device or sale of minutes for the device.

6. The method of claim 5, further comprising using user information collected during sale of the device or sale of minutes for the device to create the user account.

7. A computer-implemented method, comprising:
receiving a payment for a refill of prepaid minutes for a device;
generating an electronic personal identification number for a user account stored in a database in response to receiving the payment, wherein the user account is associated with the device; and
receiving an activation indication to assign the prepaid minutes to the user account, the activation indication comprising the electronic personal identification number.

8. A system, comprising:
a processor: and
a memory containing a program, which, when executed by the processor, is configured to perform an operation, the operation comprising:
executing a recurring charge to a user account, the user account being stored in a database; and
automatically crediting a device associated with the user account with prepaid minutes in response to executing the recurring charge.

9. The system of claim 8, further comprising a device configured to automatically collect user information from a user payment method, wherein the operation further comprises automatically collecting the user information from the user payment method and using the collected user information to create the user account.

10. The system of claim 9, wherein the user information is automatically collected by RFID or wireless or wired electronic connection.

11. The system of claim 8, further comprising a device configured to automatically collect user information from a driver's license, ID card or passport, wherein the operation further comprises automatically collecting the user information from driver's license, ID card or passport and using the collected user information to create the user account.

12. The system of claim 8, wherein the operation further comprises using user information collected during sale of the device or sale of minutes for the device to create the user account.

13. A system, comprising:
a processor; and
a memory containing a program, which, when executed by the processor, is configured to perform an operation, the operation comprising:
receiving a payment for a refill of prepaid minutes for a device;
generating an electronic personal identification number for a user account stored in a database in response to receiving the payment, wherein the user account is associated with the device; and
receiving an activation indication to assign the prepaid minutes to the user account, the activation indication comprising the electronic personal identification number.

14. A computer-readable storage medium including a program, which when executed on a processor performs an operation, the operation comprising:
executing a recurring charge to a user account, the user account being stored in database; and
automatically crediting a device associated with the user account with prepaid minutes in response to executing the recurring charge.

15. The computer-readable storage medium of claim 14, wherein the operation further comprises automatically collecting user information from a user payment method and using the collected user information to create the user account.

16. The computer-readable storage medium of claim 15, wherein the user information is automatically collected by RFID or wireless or wired electronic connection.

17. The computer-readable storage medium of claim 14, wherein the operation further comprises automatically collecting user information from a driver's license, ID card or passport.

18. The computer-readable storage medium of claim 14, wherein the operation further comprises establishing the user account at the time and point of sale of the device or sale of minutes for the device.

19. The computer-readable storage medium of claim 18, wherein the operation further comprises using user information collected during sale of the device or sale of minutes for the device to create the user account.

20. A computer-readable storage medium including a program, which when executed on a processor performs an operation, the operation comprising:
receiving a payment for a refill of prepaid minutes for a device;
generating an electronic personal identification number for a user account stored in a database in response to receiving the payment, wherein the user account is associated with the device; and
receiving an activation indication to assign the prepaid minutes to the user account, the activation indication comprising the electronic personal identification number.
